(19) United States
(12) Patent Application Publication
(10) Pub. No.: US 2026/0228266 A1
(43) Pub. Date: Aug. 6, 2026

(54) SYSTEMS AND METHODS FOR MANAGING COMMUNICATION WITH A COMPUTING ENVIRONMENT

(71) Applicant: Groundswell Corporation, McLean, VA (US)

(72) Inventor: Aram Serpekian, McLean, VA (US)

(73) Assignee: Groundswell Corporation, McLean, VA (US)

(21) Appl. No.: 19/462,729

(22) Filed: Jan. 28, 2026

Related U.S. Application Data
(60) Provisional application No. 63/752,413, filed on Jan. 31, 2025.
(60) Provisional application No. 63/752,381, filed on Jan. 31, 2025.

(51) Int. Cl. G06F 16/335; G06F 16/3331

(52) U.S. Cl. CPC G06F 16/335; G06F 16/3331

(57) ABSTRACT

Disclosed are systems and methods for managing communication with a computing environment using a gateway computing device. The system obtains data files in a first file format, which are associated with a first user identifier. Upon obtaining these data files, the system generates an entry in the semantic dataset based on the data files, representing them in a second file format compatible with the semantic dataset. The system also obtains a query in a first query format, which includes one or more criteria. In response to obtaining the query, the system reformats it to generate an updated query that aligns with the criteria and is compatible with the second file format. Finally, the system executes the updated query on the semantic dataset to generate a query response, which includes at least a portion of the data files in the second file format.

### CROSS-REFERENCE TO RELATED APPLICATION

This application claims the benefit of, and priority to, U.S. Provisional Patent Application Nos. 63/752,381, and 63/752,413, entitled “Systems and Methods for Managing Communication with a Computing Environment,” and filed on Jan. 31, 2025, each of which is incorporated by reference herein in its entirety for all purposes.

### TECHNICAL FIELD

This application relates, generally, to systems and methods for managing communication with a computing environment and, in some embodiments, to systems and methods for managing communication with a computing environment using a gateway computing device.

### BACKGROUND

Conventional approaches to computing system architectures, including enterprise or distributed system architectures, often allow users to directly upload data from client devices to servers for storage and subsequent retrieval. While this can alleviate the need to maintain significant computing and/or storage resources on the client devices, this direct access between the client devices and the servers can present significant security vulnerabilities. For example, direct communication between client devices and the server can increase the risk of data interception, unauthorized access, and potential code injection attacks by malicious third parties. To reduce these risks, security measures can be implemented, but conventional approaches cybersecurity in are complex and resource-intensive. For example, advanced encryption protocols, sophisticated authentication mechanisms, and intrusion detection systems can be implemented, which require the dedication of computing resources and additional network communication between the client devices and the server.

### SUMMARY

For the aforementioned reasons, there is a need for systems and methods that manage communication with a computing environment. Disclosed herein are systems and methods capable of addressing the above-described shortcomings and may provide any number of additional or alternative benefits and advantages. The present disclosure generally relates to systems, methods, and computer-readable media for managing communication between client devices and a server via a gateway computing device. In one aspect, a gateway computing device obtains an initial request from a client, determines a mapping between the request and a server-maintained profile, and generates an updated request based on that mapping and any hierarchical access relationships. The gateway computing device can provide the updated request to the server to execute permitted operations, obtains the server's response, and returns the response to the client for display via a graphical user interface. In certain embodiments, the gateway computing device can coordinate with a computing environment to allow for secure file storage operations, generation of temporary access links for large transfers, and reformat queries and results in connection with semantic datasets indexed in a latent space to enforce profile-based access controls.

Embodiments may include a system having one or more computing devices having one or more processors. The one or more processors can be configured to obtain, by a gateway computing device, an initial request to cause a server that is accessible by the gateway computing device to perform one or more operations. In some aspects, the one or more processors can be configured to determine, by the gateway computing device, a mapping between the initial request and a profile maintained by the server that is associated with the initial request. The one or more processors can be configured to generate, by the gateway computing device, an updated request based on the initial request and the mapping between the initial request and the profile. In aspects, the one or more processors can be configured to provide, by the gateway computing device, the updated request to the server to cause the server to execute one or more operations in accordance with the initial request. The one or more processors can be configured to obtain, by the gateway computing device, a response to the initial request, the response representing the one or more operations executed by the server in response to the updated request. In some aspects, the one or more processors can be configured to provide the response to a client device that initiated the initial request to cause the client device to generate a graphical user interface (GUI) in accordance with the response.

In some aspects, the one or more processors configured to determine the mapping can be configured to extract a user identifier based on the initial request and compare the user identifier to the mapping to determine a profile identifier within a profile structure. The one or more processors configured to generate the updated request can be configured to generate the updated request based on a hierarchical position of the profile identifier within the profile structure.

In some aspects, the one or more processors configured to generate the updated request can be configured to generate the updated request to configure the server to execute the one or more operations in accordance with the hierarchical position of the profile. In at least some aspects, the one or more processors configured to configure the server to execute the one or more operations in accordance with the hierarchical position of the profile can be configured to configure the server to execute one or more queries based on the request; and in response to receiving query results in accordance with the one or more queries, update the query results based on the hierarchical position of the profile. In some aspects, the one or more processors can be further configured to obtain, by the gateway computing device, a storage request to cause the server to store at least one file that is associated with the profile; and provide, by the gateway computing device, the storage request to the server to cause the server to store the at least one file in accordance with the profile.

In some aspects, the one or more processors can be further configured to obtain, by the gateway computing device, a temporary access link that includes instructions for configuring a communication connection with the server within a threshold period of time measured from a point at which the temporary access link is created; and provide, by the gateway computing device, the temporary access link to a client device to allow the client device to establish the communication connection with the server. In some aspects, the one or more processors can be further configured to determine that a size of the at least one file satisfies a transfer threshold. The one or more processors configured to obtain the temporary access link can be configured to obtain the temporary access link in response to determining that the size of the at least one file satisfies the transfer threshold.

Embodiments may include a computer-implement method. The method can include obtaining, by one or more processors, an initial request to cause a server that is accessible by the gateway computing device to perform one or more operations; determining, by the one or more processors, a mapping between the initial request and a profile maintained by the server that is associated with the initial request; generating, by the one or more processors, an updated request based on the initial request and the mapping between the initial request and the profile; providing, by the one or more processors, the updated request to the server to cause the server to execute one or more operations in accordance with the initial request; obtaining, by the one or more processors, a response to the initial request, the response representing the one or more operations executed by the server in response to the updated request; and providing, by the one or more processors, the response to a client device that initiated the initial request to cause the client device to generate a graphical user interface (GUI) in accordance with the response.

In some aspects, determining the mapping includes extracting, by the one or more processors, a user identifier based on the initial request and comparing, by the one or more processors, the user identifier to the mapping to determine a profile identifier within a profile structure. In some aspects, generating the updated request can include: generating, by the one or more processors, the updated request based on a hierarchical position of the profile identifier within the profile structure.

In at least some aspects, generating the updated request can include generating, by the one or more processors, the updated request to configure the server to execute the one or more operations in accordance with the hierarchical position of the profile. In some aspects, configuring the server to execute the one or more operations in accordance with the hierarchical position of the profile can include configuring, by the one or more processors, the server to execute one or more queries based on the request; and in response to receiving query results in accordance with the one or more queries, updating, by the one or more processors, the query results based on the hierarchical position of the profile.

In some aspects, the method can further include obtaining, by the one or more processors, a storage request to cause the server to store at least one file that is associated with the profile; and providing, by the one or more processors, the storage request to the server to cause the server to store the at least one file in accordance with the profile. In aspects, method can further including obtaining, by the one or more processors, a temporary access link that includes instructions for configuring a communication connection with the server within a threshold period of time measured from a point at which the temporary access link is created; and providing, by the gateway computing device, the temporary access link to a client device to allow the client device to establish the communication connection with the server.

In at least some aspects, the method can further include determining, by the one or more processors, that the size of at least one file satisfies a transfer threshold. In some aspects, obtaining the temporary access link can include obtaining, by the one or more processors, the temporary access link in response to determining that the size of at least one file satisfies the transfer threshold.

Embodiments may include a non-transitory computer-readable medium. The non-transitory computer-readable medium can store instructions thereon that, when executed by one or more processors, cause the one or more processors to obtain an initial request to cause a server that is accessible by the gateway computing device to perform one or more operations; determine a mapping between the initial request and a profile maintained by the server that is associated with the initial request; generate an updated request based on the initial request and the mapping between the initial request and the profile; provide the updated request to the server to cause the server to execute one or more operations in accordance with the initial request; obtain a response to the initial request, the response representing the one or more operations executed by the server in response to the updated request; and provide the response to a client device that initiated the initial request to cause the client device to generate a graphical user interface (GUI) in accordance with the response.

In some aspects, the instructions that cause the one or more processors to determine the mapping can cause the one or more processors to extract a user identifier based on the initial request; and compare the user identifier to the mapping to determine a profile identifier within a profile structure. The instructions that cause the one or more processors to generate the updated request can cause the one or more processors to generate the updated request based on a hierarchical position of the profile identifier within the profile structure. In some aspects, the instructions that cause the one or more processors to generate the updated request can cause the one or more processors to generate the updated request to configure the server to execute the one or more operations in accordance with the hierarchical position of the profile. In at least some aspects, the instructions that cause the one or more processors to configure the server to execute the one or more operations in accordance with the hierarchical position of the profile can cause the one or more processors to configure the server to execute one or more queries based on the request; and in response to receiving query results in accordance with the one or more queries, update the query results based on the hierarchical position of the profile.

In at least some aspects, the instructions can further cause the one or more processors to obtain a storage request to cause the server to store at least one file that is associated with the profile; and provide the storage request to the server to cause the server to store the at least one file in accordance with the profile.

In some aspects, the instructions can further cause the one or more processors to obtain a temporary access link that includes instructions for configuring a communication connection with the server within a threshold period of time measured from a point at which the temporary access link is created; and provide the temporary access link to a client device to allow the client device to establish the communication connection with the server.

By virtue of the implementation of a gateway computing device for managing communication with a computing environment as described herein, several technical advantages are achieved. First, by acting as an intermediary between client devices and servers, the gateway computing device can enhance security by reducing direct attack vectors and minimizing the risk of data interception, unauthorized access, and potential code injection attacks. The gateway computing device can implement robust security measures such as advanced encryption protocols, sophisticated authentication mechanisms, and intrusion detection systems, providing a centralized point for security management and reducing the need for constant updates across all client devices attempting to access the computing environment. Additionally, implementation of the gateway computing device as described herein offers improved data management capabilities, allowing for local data aggregation, compression, and analysis at the gateway level. This not only reduces latency and bandwidth requirements but also allows for more efficient data handling and faster decision-making processes.

Furthermore, the gateway computing device enhances network performance and reliability by optimizing data flow and ensuring efficient routing of information. For example, the gateway computing device can support protocol conversion, allowing for seamless communication between disparate systems and facilitating interoperability in heterogeneous network environments. This is particularly beneficial for integrating legacy systems with modern technologies without requiring extensive infrastructure overhauls (particularly where legacy client devices are incapable of being overhauled due to the lack of support and/or obsolescence for the hardware included therein). By centralizing functionality in the gateway computing device as described, scalability can be improved and greater flexibility in adapting to evolving network demands and security threats can be achieved.

At least one embodiment relates to a system. The system can include one or more processors. The one or more processors can be configured to: generate a semantic dataset configured to index a plurality of entries in accordance with a latent space; obtain data files having a first file format, the data files associated with a first user identifier; in response to obtaining the data files, generating an entry in the semantic dataset based on the data files, the entry representing the data files in a second file format that is compatible with the semantic dataset; obtain a query having in a first query format, the query including one or more criteria; in response to obtaining the query, reformat the query to generate an updated query in accordance with the one or more criteria that is compatible with the second file format; and execute the updated query on the semantic dataset to generate a query response, the query response including at least a portion of the data files in the second file format.

In some aspects, the one or more processors configured to generate the entry in the semantic dataset can be configured to execute a first encoder in accordance with the data files to generate a first embedding; and generate the entry based on the data files and the first embedding.

In at least some aspects, the one or more processors configured to receive a request to store the data files as an entry in the semantic dataset can be configured to receive a request indicating a profile identifier. The one or more processors configured to generate the entry can be configured to associate the entry with a profile identifier indicated by a request to store the data files in the semantic dataset.

In some aspects, the one or more processors configured to associate the entry with the profile identifier can be configured to determine a relative position of the profile identifier relative to a plurality of profile identifiers positioned in a profile hierarchy and associate the entry with the relative position of the profile identifier. In some aspects, the at least a portion of the data files in the second file format can be stored in accordance with a relative position of a profile identifier. The one or more processors configured to generate an updated query that is compatible with the second file format can be configured to generate the updated query based on the relative position of a profile identifier indicated by the query. And the one or more processors configured to generate the updated query can be configured to generate the updated query to be executed in accordance with a profile hierarchy to cause the query response to include at least a portion of the data files in the second file format.

In some aspects, the one or more processors can be further configured to filter the query response in accordance with a relative position of a profile identifier indicated by the query. In some aspects, the query response can include a first query response, and the one or more processors can be further configured to generate a second query response based on the first query response to represent the at least a portion of the data files in the first file format. In at least some aspects, the one or more processors can be further configured to filter the second query response in accordance with a relative position of a profile identifier indicated by the query.

In some aspects, the one or more processors can be further configured to determine a set of redactions based on a relative position of a profile identifier indicated by the query; and apply the set of redactions to the second query response.

In yet another embodiment, the techniques described herein relate to a non-transitory computer-readable medium. The non-transitory computer-readable medium can store instructions thereon that, when executed by one or more processors, cause the one or more processors to generate a semantic dataset configured to index a plurality of entries in accordance with a latent space; obtain data files having a first file format, the data files associated with a first user identifier; in response to obtaining the data files, generating an entry in the semantic dataset based on the data files, the entry representing the data files in a second file format that is compatible with the semantic dataset; obtain a query having in a first query format, the query including one or more criteria; in response to obtaining the query, generate an updated query that is compatible with the second file format; and execute the updated query on the semantic dataset to generate a query response, the query response including at least a portion of the data files in the second file format.

In some aspects, the instructions that cause the one or more processors to generate the entry in the semantic dataset can cause the one or more processors to: execute a first encoder in accordance with the data files to generate a first embedding; and generate the entry based on the data files and the first embedding. In at least some aspects, the instructions can further cause the one or more processors to receive a request to store the data files as an entry in the semantic dataset. The request can indicate a profile identifier, and the instructions that cause the one or more processors to generate the entry can cause the one or more processors to associate the entry with a profile identifier indicated by a request to store the data files in the semantic dataset.

In some aspects, the instructions that cause the one or more processors to associate the entry with the profile identifier can cause the one or more processors to determine a relative position of the profile identifier relative to a plurality of profile identifiers positioned in a profile hierarchy; and associate the entry with the relative position of the profile identifier.

In at least some aspects, at least a portion of the data files in the second file format can be stored in accordance with a relative position of a profile identifier, and the instructions that cause the one or more processors to generate an updated query that is compatible with the second file format can be configured to generate the updated query based on the relative position of a profile identifier indicated by the query. In some aspects, the instructions that cause the one or more processors to generate the updated query can cause the one or more processors to generate the updated query to be executed in accordance with a profile hierarchy to cause the query response to include at least a portion of the data files in the second file format.

In some aspects, the instructions can further cause the one or more processors to filter the query response in accordance with a relative position of a profile identifier indicated by the query. In aspects, the query response can include a first query response. The instructions can further cause the one or more processors to generate a second query response based on the first query response to represent the at least a portion of the data files in the first file format. In at least some aspects, the instructions can further cause the one or more processors to filter the second query response in accordance with a relative position of a profile identifier indicated by the query.

In some aspects, the instructions can further cause the one or more processors to determine a set of redactions based on a relative position of a profile identifier indicated by the query; and apply the set of redactions to the second query response.

In some aspects, a system is disclosed. The system can include one or more processors. The one or more processors can be configured to generate a semantic dataset configured to index a plurality of entries in accordance with a latent space; obtain data files having a first file format, the data files associated with a first user identifier; in response to obtaining the data files, generating an entry in the semantic dataset based on the data files, the entry representing the data files in a second file format that is compatible with the semantic dataset; obtain a query having in a first query format, the query including one or more criteria; in response to obtaining the query, reformat the query to generate an updated query in accordance with the one or more criteria that is compatible with the second file format; and execute the updated query on the semantic dataset to generate a query response, the query response including at least a portion of the data files in the second file format.

In aspects, the one or more processors can be configured to generate the entry in the semantic dataset are configured to: execute a first encoder in accordance with the data files to generate a first embedding; and generate the entry based on the data files and the first embedding.

By virtue of the implementation of a semantic dataset as described herein, several technical benefits can be achieved. First, by generating a semantic dataset that indexes entries in accordance with embeddings in a shared latent space, a server can efficiently organize and retrieve data as compared to conventional database organization and retrieval, reducing the need for extensive memory when analyzing and storing data. Second, the process of converting data files from a first file format to a second format compatible with the shared latent space ensures that the data is stored in a more optimized (e.g., compact) manner, further conserving memory and reducing the need for additional rows or columns that would conventionally be needed to indicate complex sets of interdependencies and/or relationships between entries in a dataset. Additionally, the system's ability to reformat queries to align with the second file format before execution minimizes the computational overhead required for query processing that can involve execution of multiple sets of operations to translate queries from one format to another. This approach allows for faster and more efficient query execution, again conserving processing power. Overall, the embodiment enhances data management and retrieval efficiency, leading to significant savings in both memory and processing resources.

### BRIEF DESCRIPTION OF THE DRAWINGS

Non-limiting embodiments of the present disclosure are described by way of example with reference to the accompanying figures, which are schematic and are not intended to be drawn to scale. Unless indicated as representing the background art, the figures represent aspects of the disclosure.

FIG. 1 illustrates a diagram of an environment for managing communication with a computing environment according to an embodiment.

FIG. 2 illustrates a flow diagram of a process for managing communication with a computing environment according to an embodiment.

FIG. 3 illustrates a flow diagram of a process that involves executing queries in a semantic dataset managed by a computing environment maintained by a server according to an embodiment.

FIG. 4 illustrates an example implementation of an environment for managing communication with a computing environment according to an embodiment.

### DETAILED DESCRIPTION

Reference will now be made to the illustrative embodiments depicted in the drawings, and specific language will be used here to describe the same. It will nevertheless be understood that no limitation of the scope of the claims or this disclosure is thereby intended. Alterations and further modifications of the inventive features illustrated herein, and additional applications of the principles of the subject matter illustrated herein, which would occur to one skilled in the relevant art and having possession of this disclosure, are configured to be considered within the scope of the subject matter disclosed herein. Other embodiments can be used, or other changes can be made without departing from the spirit or scope of the present disclosure. The illustrative embodiments described in the detailed description are not meant to be limiting of the subject matter presented.

The present disclosure is generally directed to systems, methods, and computer-readable media for managing communication between client devices and a server through a gateway computing device. In these aspects, the gateway computing device can receive an initial request from a client device, determine a mapping between the request and a server-maintained profile associated with the client device, and generate an updated request based on that mapping. The updated request can be provided to the server to execute permitted operations at a computing environment associated with the gateway computing device, and the gateway computing device can obtain a query response from the server reflecting the executed operations. The query response can then be provided to the client device for presentation via a graphical user interface.

In some aspects, the gateway computing device can be configured to extract user identifiers from the initial request to determine profile identifiers within a hierarchical profile structure. The gateway computing device can then generate updated requests and query results according to hierarchical access positions that are associated with the request (e.g., the client device that generated the request). In examples, the gateway computing device can process storage requests and coordinate with the computing environment to generate temporary access links (e.g., for large file transfers). Additionally, or alternatively, the gateway computing device can reformat the initial query for execution against semantic datasets indexed in accordance with a latent space. In some examples, the gateway computing device can filter, redact, etc., query responses based on the profile associated with the client device, execute queries in accordance with corresponding profile-based constraints, and integrate security, protocol translation, and data management functions to optimize operation and enforce access controls.

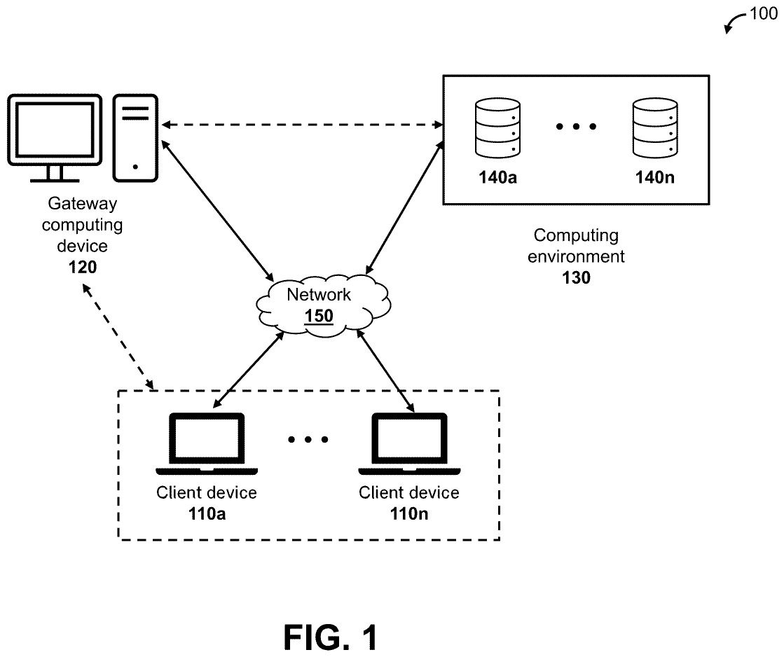

FIG. 1 Illustrates a Diagram of an Environment 100 for Managing communication with a computing environment, according to an embodiment. The environment 100 includes client devices 110a-110n (each referred to individually as a client device 110 and collectively as client devices 110, unless stated otherwise), a gateway computing device 120, a computing environment 130 and a network 150. As illustrated, the computing environment 130 includes datasets 140a-140n (each referred to individually as a dataset 140 and collectively as datasets 140, unless stated otherwise). Various components depicted in FIG. 1 can belong to an organization that is involved in controlling access to computing resources in computing environments that are the same as, or similar to, the computing environment 130 of FIG. 1. The environment 100 is not confined to the components described herein and can include additional or other components, not explicitly illustrated for brevity, which are configured to be considered within the scope of the embodiments described herein.

The client devices 110 can include any computing device including a processor and non-transitory machine-readable storage capable of executing the various tasks and processes described herein. In some embodiments, the client devices 110 can employ various processors such as central processing units (CPU) and graphics processing unit (GPU), among others. Non-limiting examples of such computing devices can include workstation computers, laptop computers, server computers, and the like. While the environment 100 includes client devices 110, other examples can include any number of client devices 110 operating in a distributed computing environment, such as a cloud environment. As described herein, the client devices 110 can be configured to receive input and establish communication connections with the gateway computing device 120 and/or one or more elements of the computing environment 130 when implementing one or more instructions provided to the client devices 110 by user for users.

The gateway computing device 120 can include any computing device including a processor and non-transitory machine-readable storage capable of executing the various tasks and processes described herein. In some embodiments, the gateway computing device 120 can employ various processors such as central processing units (CPU) and graphics processing unit (GPU), among others. Non-limiting examples of such computing devices can include workstation computers, laptop computers, server computers, and the like. In some embodiments, the gateway computing device 120 can be configured to operate as an intermediary between different networks or systems. For example, the gateway computing device 120 can facilitate communication by translating data between disparate protocols, architectures, or applications. In some examples, the gateway computing device 120 can manage network traffic, route data, and provide security features, etc.

The computing environment 130 can include any computing device including a processor and non-transitory machine-readable storage capable of executing the various tasks and processes described herein. In some embodiments, the computing environment 130 can employ various processors such as central processing units (CPU) and graphics processing units (GPU), among others. Non-limiting examples of computing environments can include workstation computers, laptop computers, server computers, and the like. The computing environment 130 includes multiple datasets 140a-140n (each referred to individually as a dataset 140 and collectively as datasets 140, unless stated otherwise). In some embodiments, the datasets 140 can be used to store and manage large volumes of data, enabling efficient data processing and analysis. In some embodiments, the computing environment 130 can be configured to communicate with one or more client devices 110 using an intermediary device such as the gateway computing device 120.

The above-mentioned components can be connected to each other through a network 150. Examples of the network 150 can include, but are not limited to, private or public local-area-networks (LAN), wireless LAN (WLAN) networks, metropolitan area networks (MAN), wide-area networks (WAN), and the Internet. The network 150 can include wired or wireless communications according to one or more standards or via one or more transport mediums. The communication over the network 150 can be performed in accordance with various communication protocols such as Transmission Control Protocol and Internet Protocol (TCP/IP), User Datagram Protocol (UDP), and IEEE communication protocols. In one example, the network 150 can include wireless communications according to Bluetooth specification sets or another standard or proprietary wireless communication protocol. In another example, the network 150 can also include communications over a cellular network, including, e.g., a GSM (Global System for Mobile Communications), CDMA (Code Division Multiple Access), and EDGE (Enhanced Data for Global Evolution) network.

With continued reference to FIG. 1, the client devices 110 can generate requests that are processed by the gateway computing device 120 to be executed by the computing environment 130. For example, a client device 110 can generate an initial request to cause a server, implemented by the computing environment 130 and accessible by the gateway computing device 120, to perform one or more operations in response to receiving input from a user or an application (executed by the client device 110). In this example, the client device 110 can process the input to generate the initial request including one or more aspects of the specific tasks or operations to be performed. And will be understood, the initial requests can involve the server performing one or more operations using one or more of the datasets 140 (which can be stored as, for example, Amazon Web Services (AWS®) S3 buckets, etc.).

In some embodiments, the client device 110 can establish a communication connection with the gateway computing device 120, which acts as an intermediary between the client device 110 and the computing environment 130. A communication connection can represent a pathway that allows data to be exchanged between devices across the network 150. In one example, a communication connection can be established before data transfer (e.g., TCP), ensuring reliable and ordered delivery. In some embodiments, a communication connection can be established between the client device 110 and the gateway computing device 120, between the gateway computing device 120 and the computing environment 130, and/or between the client devices 110 and the computing environment 130. As will be described herein, communication connections can optionally be established during a predetermined or established period of time.

In some embodiments, the gateway computing device 120 can receive the initial request from a client device 110 and determine a mapping between the request and a profile maintained by the server. For example, the gateway computing device 120 can receive the initial request from a client device 110 in response to input at the client device 110 by a user when modifying and/or searching resources accessible by the user at the computing environment 130. The gateway computing device 120 can then determine a mapping between the initial request (e.g., a user identifier, etc., included in the initial request) and a profile (e.g., for the client device 110 and corresponding user) maintained by the server, where the profile indicates one or more resources to which the user operating the client device 110 has access. In this example, the client device 110 associated with the user can have access permissions to cause portions of the computing environment 130 to execute one or more operations based on data stored by the computing environment 130. In one example, the operations can involve adding, updating, etc., data to one or more of the datasets 140. Additionally, the operations can involve executing one or more searches within the datasets based on the data stored in the one or more datasets 140. In some examples, the gateway computing device 120 can receive a response from the computing environment 130 that represents the operations executed by the computing environment 130 and provide the response to the client device. This can cause the client device 110 that generated and transmitted the initial request to output an indication of the response (e.g., a GUI, etc.).

By receiving, analyzing, and updating the initial request from client devices 110, the gateway computing device 120 can ensure that only authorized operations are performed by the computing environment 130, reducing the chances for malicious third-parties to gain access to the computing environment 130 and execute unpermitted operations. As an example, client devices 110 can assign resources maintained by the computing environment 130, such as one or more datasets 140, and periodically provide and/or update data maintained by the datasets 140 assigned to the client device 110. This can include uploading one or more documents, files, etc., to corresponding datasets 140 to be analyzed and/or searched in the future. At a later point in time, the client devices 110 with access to the datasets 140 maintaining the one or more documents, files, etc., can submit another request (e.g., another initial request) to search and/or retrieve portions or all of the documents, files, etc. In these instances, the gateway computing device 120 can receive the initial requests, confirm whether the client devices 110 are permitted to access the documents, files, etc., and we're permitted generate an updated request to cause operations to be executed by the computing environment 130 in accordance with the initial request. By acting as a gatekeeper, the gateway computing device 120 can filter and manage requests, ensuring that only legitimate and authorized requests are processed by the computing environment 130. This layered approach adds an extra level of security, making it more difficult for cyberattacks to penetrate the system implement the computing environment 130, potentially causing one or more operations that can potentially corrupt the data to unintentionally be permitted to be executed by the computing environment 130. This can reduce or eliminate the chances for a client device 110 controlled by a malicious third-party to corrupt data through targeted manipulation, inject malware to consume computing resources, or launch denial-of-service attacks to overwhelm and slow down systems, potentially causing significant operational disruptions.

In some embodiments, the data maintained by the datasets 140 of the computing environment 130 can include metadata that is generated and stored when the data is initially entered into the datasets. The metadata can include, for example, indicators associated with lists of users, record identifiers, record types, and text strings related to the underlying data. This metadata can be used to facilitate filtering operations within the computing environment 130 by allowing relevant systems to compare query parameters against the metadata instead of directly accessing the full records. For instance, when a query is executed by a client device 110, the gateway computing device 120 and/or the server included in the computing environment 130 can verify whether the client device 110 has access permissions corresponding to the metadata indicators before retrieving the requested data. By using metadata-based filtering, only those client devices 110 associated with user identifiers or roles having permission to access the underlying records are able to query and retrieve the corresponding documents or files. This approach enhances security and allow for access to only the stored information permitted to be accessed in accordance with predefined user permissions and organizational rules represented in the metadata.

In some embodiments, the gateway computing device 120 can host a conversational interface or chatbot to assist users during the query generation and refinement process. The chatbot can serve as an intermediary between the client device 110 and the computing environment 130, obtaining a query from the user, interpreting its intent, and interacting with the underlying datasets or semantic datasets 140 maintained in the computing environment 130. The chatbot can parse natural-language inputs from the user and translate them into structured or semantically enriched queries for execution. Once the chatbot obtains initial search results, the chatbot can use those results to generate follow-up questions, clarifications, or query refinements, allowing the user to iteratively narrow down or expand their query scope through natural conversation without requiring direct manipulation of query syntax.

In some examples, the chatbot can operate over all datasets 140 maintained by the computing environment 130 or be constrained to access only those datasets associated with permissions assigned to the user or client device 110 initiating the query. For instance, the chatbot can be configured to adapt its retrieval operations based on the profile mapping described above, ensuring that responses are filtered to include only data permitted for access by the corresponding client device 110. In this example, the chatbot can maintain compliance with access control policies while still providing a seamless conversational experience to the user.

In at least some embodiments, the chatbot can implement query augmentation techniques by retrieving additional data from datasets 140 stored in the computing environment 130 to provide contextual enrichment. For example, upon receiving an initial query from a client device 110, the chatbot can analyze the textual structure of the query, retrieve relevant information from the datasets directly or through the use of embeddings in a latent space, and use this supplementary context to refine the query. This refinement process can involve re-ranking or expanding the scope of the search to include related content while remaining consistent with the user's access privileges. The refined or contextually enhanced query can then be executed by the computing environment 130 to produce an improved response that reflects both the original query and the additional data discovered during the chatbot-assisted interaction.

In some embodiments, a retrieval-augmented generation model can be implemented by the chatbot and configured in accordance with different types of architectures depending on the operational requirements of the gateway computing device 120 and/or the computing environment 130 shown in FIG. 1. The retrieval-augmented generation model can include an encoder-decoder architecture in which the encoder generates vector embeddings of input data or tokens received from a client device 110, and the decoder produces output sequences that represent reformulated queries or context-specific responses. In other embodiments, a dual-encoder architecture can be implemented in which a first encoder processes queries received from the client device 110 while a second encoder processes candidate responses or context data retrieved from the semantic dataset 140 maintained by the computing environment 130. Additionally, or alternatively, the retrieval-augmented generation model can implement a unified transformer architecture that integrates retrieval and generation functionality into a shared attention mechanism, thereby allowing retrieval alignment and content generation to occur within a common latent space while reducing transfer latency between modules. Depending on the deployment configuration, the retrieval-augmented generation model can execute on the gateway computing device 120 for applications involving query reformulation and routing optimization, or on the computing environment 130 for large-scale retrieval and contextual reasoning involving extensive portions of stored semantic data.

The retrieval-augmented generation model can receive several layers of input data depending on the operational configuration of the retrieval-augmented generation model. The primary input can include a query, request, or message generated by the chatbot or graphical interface of a client device 110 and transmitted to the gateway computing device 120. The retrieval-augmented generation model can also obtain secondary input signals including embeddings retrieved from the semantic dataset 140 stored within the computing environment 130, metadata associated with user profiles, contextual identifiers, historical queries, and other environmental parameters. These inputs can be processed by the encoder component of the retrieval-augmented generation model to produce high-dimensional vector representations that capture semantic relationships between the elements of the input. The output produced by the retrieval-augmented generation model can include context vectors, response embeddings, or structured sequences that represent updated queries or reformulated instructions. The output can be provided to the gateway computing device 120 to generate responses for the client device 110 or to initiate subsequent operations within the computing environment 130.

Training of the retrieval-augmented generation model can be performed within the computing environment 130 using stored data representing paired queries and reference responses derived from prior operations between the client devices 110 and the gateway computing device 120. During training, the encoder of the retrieval-augmented generation model can transform each input query into an embedding within a latent space, while the decoder generates one or more candidate sequences conditioned on these embeddings and on retrieved context from the semantic dataset 140. The difference between the generated output and the expected reference output can be computed as a loss function, and the resulting error can be propagated backward throughout the encoder and decoder layers to update weights of the retrieval-augmented generation model. This backpropagation process can allow for iterative refinement of the retrieval and generation components, improving the accuracy of semantic alignment between input embeddings and associated output responses. The training process can be distributed across the computing environment 130, while inference of the trained model can occur locally on the gateway computing device 120 or remotely within the computing environment 130 depending on computational availability and network throughput.

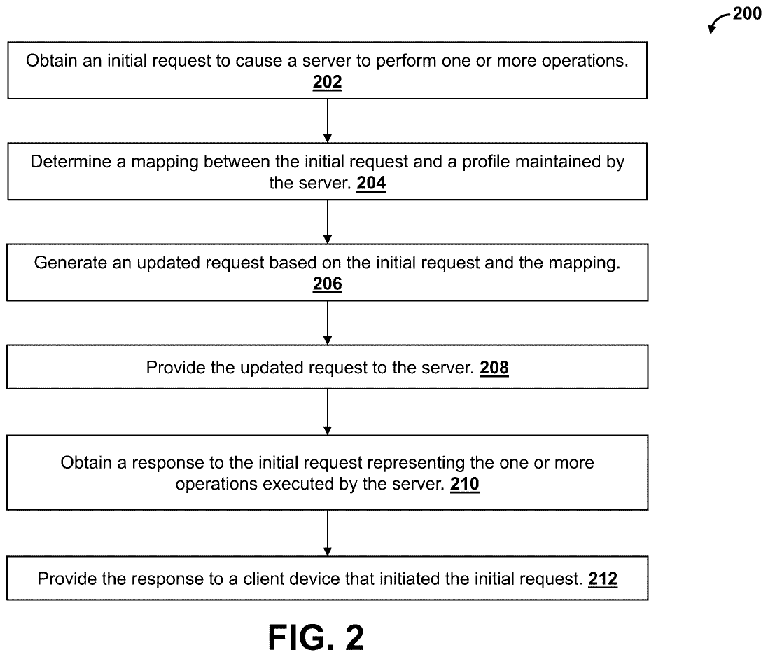

Referring to FIG. 2, illustrated is a flow diagram of a process 200 for managing communication with a computing environment, according to an embodiment. The process 200 includes operations 202-212. However, other embodiments can include additional or alternative operations or can omit one or more operations altogether. The process 200 is described as being executed by one or more devices of the environment 100 of FIG. 1, which can include a gateway computing device that is the same as, or similar to, the gateway computing device 120 described in FIG. 1. However, one or more steps of the process 200 can be executed by any number of computing devices operating in the distributed computing system described in FIG. 1. For instance, one or more computing devices can locally perform part, or all of the operations described in FIG. 2, alone or in coordination with the other devices of FIG. 1.

At operation 202, the gateway computing device can obtain an initial request to cause the server to perform one or more operations. In an example, the gateway computing device can obtain the initial request to cause a server to perform operations from a client device while operating as an intermediary between client devices and the server. In this example, the gateway computing device can receive the initial request from the client device over a private network or a public network (e.g., the Internet). The gateway computing device can be configured to communicate with the client device and receive the initial request via an application programming interface (API) by establishing a communication connection with the client device in accordance with the API.

In some embodiments, the gateway computing device can receive the initial request, where the initial request is associated with a storage request that causes data to be stored in a dataset (e.g., as an entry in a semantic dataset as described herein). For example, the initial request can be generated by the client device in response to input at the client device that identifies data to be stored in a dataset assigned to the client device. The dataset can include a dataset maintained by the server described herein. In some embodiments, the data to be stored can include one or more documents (including strings of text), files, etc., and the initial request can be configured to cause the server to store the data in association with a profile mapped to (e.g., correlated with) the dataset. While the present disclosure discusses the storage of data associated with one or more documents, files, etc., it will be understood that the present disclosure is not limited to these file types and that other file types are contemplated as being covered. The profile can be associated with a user in control of the client device.

In some embodiments, the initial request can include the data to be stored in the dataset maintained by the server. For example, the client device can receive input identifying the data to be stored in the dataset. The client device can then identify the data stored locally at the client device or in a storage device accessible by the client device. In this example, the client device can include the data specified by the input with the initial request or an indication of where the data is stored (e.g., on a remote device that can be accessed by the gateway computing system). Additionally, or alternatively, the client device can also include one or more identifiers associated with the client device and/or the user controlling the client device with the initial request. This can allow the gateway computing device to determine a mapping between the initial request and a dataset maintained by the server.

In some embodiments, the gateway computing device can receive an initial request that includes an indication of the size of the data to be stored in the dataset maintained by the server. For example, the gateway computing device can receive an initial request that indicates the size of the data to be stored satisfies a transfer threshold indicating a threshold value. The threshold value can indicate a point at which data to be uploaded to the server and stored in the dataset is larger than the gateway computing device is configured to process. In these examples, the gateway computing device can generate an updated request that is configured to cause the server to generate and provide a temporary access link according to which the client device can upload the data to the server. In some examples, the gateway computing device can generate the temporary access link and provide the temporary access link to both the server and the client device that transmitted the initial request.

At operation 204, the gateway computing device can determine a mapping between the initial request, and a profile maintained by the server. For example, the gateway computing device can determine the mapping maintained by the gateway computing device and/or the server, where the profile corresponds to a profile identifier that is associated with (e.g., mapped to) the dataset of a computing environment maintained by the server. The profile can be established and mapped based on initial communication between the client device and the gateway computing device prior to the client device generating and transmitting the initial request. For example, the client device can communicate with the gateway computing device to establish a profile and map (e.g., allocate) resources in the computing environment maintained by the server to the profile for the client device. In some embodiments, the profile can be associated with a user controlling the client device. In embodiments, where multiple client devices are associated with a single organization or a group of users that are associated with the organization, the mapping can be between one or more of (e.g., each of) the client devices associated with the organization and the datasets associated with one or more of (e.g., each of) the client devices.

In some embodiments, the gateway computing device can determine the mapping by extracting a user identifier from the initial request. The gateway computing device can then compare the user identifier to the mapping which can include multiple user identifiers corresponding to multiple client devices. Where the user identifier matches an existing user identifier associated with the mapping, the gateway computing device can determine a profile identifier that corresponds to the user identifier within a profile structure. The profiling structure can indicate one or more datasets maintained by the server and the computing environment that are assigned to corresponding profile identifiers. The gateway computing device can then generate an updated request as described herein using the mapping between the user identifier extracted from the initial request and the profile identifier indicated by the mapping.

In some environments, the mapping can establish a hierarchy of profile identifiers. For example, the mapping can establish a hierarchy of profile identifiers according to designations of the users controlling the user device within an organization. In an example, the hierarchy can indicate that one or more profile identifiers of individuals (e.g., included in an organization) have a first degree of access to the datasets maintained by the computing environment 130, and the hierarchy can similarly indicate that one or more profile identifiers of individuals (e.g., included in the organization) have a second degree of access to the datasets. In this example the first degree of access can correspond to (e.g., allow for) greater access to more datasets within the computing environment than the second degree of access which can be limited to specific datasets within the computing environment. In this way, the mapping can establish access control between individuals with higher levels of permissions within the organization as opposed to individuals with lower levels of permission in the organization.

In some examples, where individuals are associated with different organizations, the mapping can establish access control that maps profiles of individuals to specific organizations with corresponding datasets within the computing environment. Similarly, in this way, the mapping can establish access control on a per-organization basis, allowing for multiple organizations to use a common resource (e.g., a common database storing multiple datasets) while enforcing access control and preventing unintended access and execution of operation by client devices to datasets the client devices should not have access to it.

At operation 206, the gateway computing device can generate an updated request based on the initial request and the mapping. For example, the gateway computing device can generate an updated request based on the initial request and the mapping that is configured to cause the server to execute one or more operations in association with the data sets mapped to the client device. In one example, the gateway computing device can generate the updated requests by including (e.g., adding) the profile identifier corresponding to the user identifier included in the initial request. The gateway computing device can then provide the updated request to the server as described herein.

In some embodiments, the updated request can configure the server to execute one or more operations. For example, the updated request can configure the server to execute one or more operations on the datasets maintained by the computing environment of the server. In this example, the one or more operations can include one or more queries, one more storage requests (e.g., inserts) that allow for the storage of data as described herein into the datasets, one or more deletes that allow for the removal of data from the data sets, one or more updates that allow for the modification of data included in the data sets, etc., included in the dataset maintained by the computing environment.

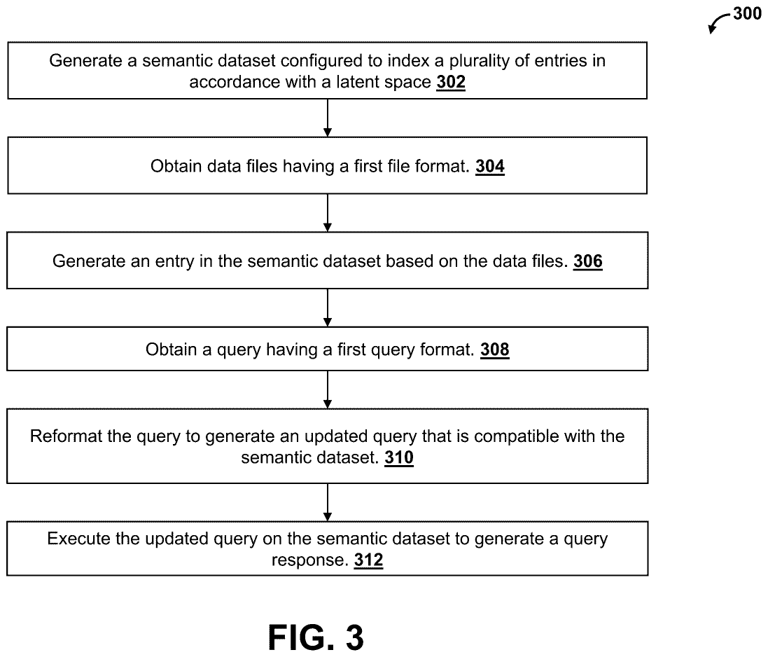

In some embodiments, the initial request and/or the updated request can include a query that is configured to cause the server to execute the query on the data set. For example, the initial request can include a query that is configured to cause the server to return at least a portion of the data accessible by the client device in the dataset maintained by the server. In some examples, where the initial request is provided by a client device that is mapped to a profile identifier as described herein, the initial request can be configured to cause the server to return a queer response in accordance with a hierarchical position of the profile relative to other profiles within an organization that has access to the dataset being queried. Additional details regarding how a query can be configured and executed on a dataset maintained by the server are described below with respect to process 300 of FIG. 3.

At operation 208, the gateway computing device can provide the updated request to the server. In some embodiments, the gateway computing device can provide the updated request to the server to cause the server to execute one or more operations in accordance with the updated request. The updated request can be based on the initial request and the mapping that establishes a correlation between the client device (e.g., the profile associated with client device) and one or more datasets maintained by the server. In examples, the server can then analyze the updated request and generate a response message that either confirms that the data was stored in the dataset or establishes a temporary access link according to which the client device can upload the data to the dataset maintained by the server. Additionally, or alternatively, server can then analyze the updated requests and execute a query in accordance with the updated request described herein.

The response message can include instructions associated with a temporary access link according to which a communication connection can be established with the server to upload the data specified by the initial request. For example, the instructions can be associated with the temporary access link established by the server to allow the client device associated with the initial request during a period of time. The period of time can include a predetermined period of time where connectivity will be available to the client device and can have an offset from the point at which the initial request was generated the updated request was generated, the updated request was received by the server, and/or the temporary access link was provided by the server.

At operation 210, the gateway computing device can obtain a response to the initial request representing the one or more operations executed by the server. For example, the gateway computing device can obtain a response such as a confirmation message from the server in response to one or more operations being executed by the server (e.g., when storing data in the datasets maintained by the server). In another example, the week computing device can obtain a response that includes a query response representing the execution of a query in accordance with the initial request by the server. In these examples, the response can represent the one or more operations that were executed by the server. This representation can include an indication of whether or not the operations were successfully executed, not successfully executed, etc.

In some embodiments, the gateway computing device can provide a response message to the client device in response to the initial request. For example, the gateway computing device can generate a response message indicating that the data was uploaded to the corresponding dataset maintained by the server. In another example, where the data satisfies a transfer threshold, the response message can include the temporary access link established by the server according to which the client device can establish a communication connection during a period of time (e.g., a threshold period measured starting when the temporary access link is created) and upload the data to the dataset. This can allow for data to be uploaded to the server regardless of whether the gateway computing device is configured to upload such data directly. By managing data transfers using a gateway computing device as described for smaller transfers to reduce server load, while larger transfers are handled directly by the server via a temporary link, security can be enhanced and performance improved by reducing network congestion and exposure of the server infrastructure to requests that involve smaller and larger files. The dual approach can allow for sustained performance as the number of client devices accessing the server scales up, with the gateway handling higher volumes of small requests compared to larger transfers. This reduces the need to frequently establish communication connections between client devices and the server, lowering resource consumption on the server.

At operation 212, the gateway computing device can provide the response to a client device that initiated the initial request. In some embodiments, the response can provide one or more indications depending on the specific scenario and system configuration. For example, the gateway computing device can provide a simple acknowledgment response to the client device, to indicate that the data included in the initial request was either successfully uploaded to the dataset maintained by the server or that the upload was unsuccessful (e.g., whether the upload encountered any issues). This type of response can allow the client device to confirm the status of the data transmission and take appropriate actions if needed.

In other examples, the gateway computing device can provide a more complex response message to the client device. This response message can include a temporary access link, which serves as a secure and time-limited means for the client device to establish a communication connection directly with the server. Using this temporary access link, the client device can then proceed to upload the data to the dataset maintained by the server. This approach can be particularly useful in scenarios where large amounts of data need to be transferred, or when additional security measures are required for the data upload process. In some examples, the response provided by the gateway computing device can also include metadata or additional instructions for the client device. This can include information such as the expected format for data uploads, any size limitations, or specific protocols to be followed during the upload process.

In some embodiments, after receiving a response message including a temporary access link, the client device can upload the data directly to the data set by establishing a communication connection with the server in accordance with the temporary access link. In some examples, the client device can parse the data locally before sending it to the server, reducing the amount of data that needs to be transmitted at once. The client device can implement a streaming parser that processes the data in segments. In this example, the parser can read the large file in small portions, analyze each segment, and discard unnecessary data. In some examples, the client device can use memory-efficient data structures like tries or suffix arrays to index and search the data without loading it entirely into memory. The parsed results can then be sent to the server in a more compact format, significantly reducing the upload size. In an example involving log files, the client device can extract only specific fields or events of interest, discarding irrelevant entries before transmission. This approach can effectively handle files that are too large to upload in their entirety, while still providing the server with the necessary information for further processing.

In some embodiments, in response to successful storage of the data in the dataset maintained by the server, a confirmation message (e.g., a response) can be generated by the server and provided to the client device. For example, where the data was included in the initial request and successfully uploaded by the gateway computing device to the server to be stored in the dataset(s) corresponding to the client device, the confirmation message can be generated by the server and provided to the gateway computing device. The gateway computing device can, in turn, provide an indication (e.g., the confirmation message, etc.) to the client device that the data was successfully uploaded to the dataset. In another example, where the data was uploaded directly from the client device to the server using a temporary access link, the server can generate and directly transmit the confirmation message to the client device. Similarly, in the examples described herein, where an upload of data fails, the gateway computing device can generate a message indicating that the upload failed and provide the message either directly or indirectly to the client device. In these examples, the client device can receive the confirmation message and generate a graphical user interface (GUI) in accordance with the confirmation message. The GUI can include a visual representation that indicates whether or not the data was successfully uploaded to the dataset maintained by the server.

Referring to FIG. 3, illustrated is a flow diagram of a process 300 that involves executing queries in a semantic dataset managed by a computing environment maintained by a server, according to an embodiment. The process 300 includes operations 302-312. However, other embodiments can include additional or alternative operations or can omit one or more operations altogether. The process 300 is described as being executed by one or more devices of the environment 100 of FIG. 1, which can include a gateway computing device that is the same as, or similar to, the gateway computing device 120 described in FIG. 1 and a computing environment implemented by a server that can be the same as, or similar to, the computing environment 130 of FIG. 1. However, one or more steps of the process 300 can be executed by any number of computing devices operating in the distributed computing system described in FIG. 1. For instance, one or more computing devices can locally perform part, or all of the operations described in FIG. 3, alone or in coordination with the other devices of FIG. 1.

At operation 302, a server maintaining a computing environment can generate a semantic dataset configured to index a plurality of entries in accordance with a latent space. For example, a server implementing a computing environment (e.g., that is the same as, or similar to, the computing environment 130 of FIG. 1) can generate a semantic dataset (e.g., that is the same as, or similar to, the datasets 140 of FIG. 1). The semantic dataset can be configured to index a plurality of entries that correspond to some or all of one or more data files in accordance with a latent space. The latent space (also referred to as an embedding space), can include a multi-dimensional space where similar items are positioned closer to each other based on their latent variables. In examples, these latent variables can derive from the similarities between the data files represented by these latent variables and can include embeddings generated as described herein. In some examples, the dimensionality of the latent space can be lower than the original feature space, making it a form of dimensionality reduction and data compression. By compressing the data files as described into a lower-dimensional form, the memory consumption involved and/or storing the data files can be reduced significantly, improving computational efficiency while also allowing for later-generated queries to be executed as described herein.

In an example, the server can receive a request to store data files as an entry in the semantic dataset. For example, the server can receive a request to store data files a one or more entries (e.g., corresponding to the entire data file or portions thereof). The request can indicate a profile identifier that is correlated with the data files to indicate the user that caused the data files to be included in the semantic dataset. In some embodiments, in response to obtaining an indication of the data files at a client device (e.g., based on input provided by the user at the client device), the request can be provided by a gateway computing device managing communication between client devices and the server. Additionally, or alternatively, the request can be provided by the client device directly to the server (e.g., using a temporary access link). In these examples, the server can associate (e.g., index) the entry generated based on the data files in the semantic dataset using the profile identifier indicated by the request when storing the data files in the semantic dataset.

In some examples, to associate the entry with the profile identifier, the server can determine a relative position of the profile identifier relative to a plurality of profile identifiers maintained in a hierarchy. For example, the server can maintain the semantic dataset and allow access to multiple client devices that are correlated with a plurality of profile identifiers. In this example, the client devices can be controlled by users that have varying degrees of access to the dataset, along with varying permissions. For example, some users can have relatively lower access (e.g., can be permitted to access files created by that specific user or a subset of users within their organization), where others can have higher access (e.g., can be permitted to access files created by multiple users within their organization). In another example, some users can have relatively lower permissions (e.g., can cause a subset of all possible operations executable by the server to be performed such as read-only permissions or the ability to query a subset of the semantic dataset) where others can have higher permissions (e.g., can cause a greater number of operations to be performed). In examples, users with lower permissions can be permitted to cause the server to execute queries on portions of the semantic datasets reserved and/or maintained for that user in the computing environment, whereas users with higher permissions may be permitted to query and/or modify larger portions of the semantic datasets maintained in the computing environment. In some embodiments, in response to receiving a request (e.g., an initial request, etc.) from a client device, the server can compare the relative position of the profile identifier included in the request and determine whether the operations identified by the client device are permitted. The server can then execute, or forgo executing, the operations associated with the initial request and/or generate an updated query to obtain query results as described herein directed to portions of the semantic dataset that the profile identifier indicates are permitted to be accessed.

At operation 304, the server can obtain data files having a first file format. For example, the server can obtain data files having a first file format as a request to store data files as an entry (similar to as described above). The data files can be associated with a user identifier that is correlated with a profile identifier usable to index entries in the semantic dataset. In this example, the server can receive files through a gateway computing system that manages communication between the server and a client device providing the data files as described herein. In some examples, the gateway computing device can filter files based on parameters like file type, transferability, or attributes of the profile corresponding to the profile identifier indicated by a request before sending them to the server. In some embodiments, the gateway computing device can append metadata to the files, including a file ID, name, type, creation time, modification time, size, and source account, which the server can then use to associate the files with a specific profile identifier. Additionally, or alternatively, the metadata can be used by the server to filter and/or redact the data files returned in response to execution of one or more operations in accordance with the updated queries described.

In some embodiments, the server can obtain (e.g., receive) data files in a file format (e.g., a first file format) from the gateway computing device and/or from the client device. For example, the server can obtain the data files, where the data files contain fields that organize aspects of the data files. In some examples, the data files can include fields representing documents (form documents, unstructured documents, etc.). In some embodiments, the server can receive data files that contain fields used to identify and associate the data with a specific user or entity, such as fields for user IDs, account numbers, or other unique identifiers. This association can allow the server to confirm that the data is correctly attributed to the right user or entity in the semantic dataset, and control the content included in subsequently-received queries. As will be understood, the file format can be configured to organize plain text files where each line represents a record and/or fields within each record. By receiving data in this format, the server can efficiently parse and process the data files, extracting the necessary fields to identify and associate the data with the appropriate user or entity when generating entries to include in the semantic dataset. This can allow the server to accurately store the data files and, subsequently, retrieve portions of the data files in response to queries as described herein.

At operation 306, the server can generate an entry in the semantic dataset based on the data files. For example, the server can generate the entry in the semantic dataset based on data files obtained by a gateway computing device and/or a client device as described herein. In some embodiments, the entry can (at least in part) represent the data files in a second file format compatible with the semantic dataset. For example, the server can execute an encoder in accordance with at least a portion of the data files to generate at least one embedding. In some embodiments, the server can then generate the entry based on to include both the data files and the embedding. For example, the server can create a dictionary structure for each file, including a converted format of the file content and the corresponding embedding. In an example, the server can integrate the embeddings into the semantic dataset by adding them as lists to the corresponding file entries (or portions thereof where separate embeddings are generated for one or more fields within the data file). In some examples, this process can result in a semantic dataset where each file is represented by the data file originally received by the server and a numerical embedding or embeddings corresponding to a quantified semantic representation the data file (or portions thereof), providing a representation of the data in a format compatible with further semantic processing or analysis as described herein.

In some embodiments, the encoder can include an attention-based encoder. For example, the encoder can be trained as part of a transformer to receive text from data files as input and generate embeddings that encode semantic relationships among tokens in a latent space as described herein. More specifically, the encoder can first transform the input text into a series of token representations, allowing each token to be linked through a common vocabulary. In some embodiments, each token representation can be enriched by means of a self-attention mechanism, wherein multiple attention heads identify contextual interdependencies between tokens for a given subset of text (e.g., corresponding to a field) of a data file. The encoder can then apply a feed-forward network to each embedding, preserving the dimensional size while augmenting its depth with contextual information. As a result, the encoder can be configured to output a collection of embeddings (e.g., embedding vectors) that represent the text in the latent space. This can allow the server to execute operation when performing downstream tasks such as when executing queries on the semantic dataset.

In some embodiments, the server can be configured to split the tokens from the input prior to processing by the encoder. For example, the server can implement a tokenizer that segments the input text into discrete tokens representing words, subwords, or characters depending on the configuration used for semantic encoding. The tokenizer can utilize predefined vocabularies or dynamically build token dictionaries that are used to maintain consistent tokenization across all operations. In some implementations, the server can normalize the input during tokenization, performing operations such as converting text to lowercase, removing extraneous punctuation, and handling special or compound words to allow for uniform representation. The resulting tokens can then be converted into token identifiers that serve as inputs to the encoder, allowing for efficient mapping and embedding generation during subsequent processing stages.

In some embodiments, the server can update an existing entry in a semantic dataset based on data files obtained by a gateway computing device and/or a client device. For example, the server can receive a request to execute operations to update (e.g., add to, remove from, change, etc.) one or more entries maintained in the semantic dataset. In this example, the server can update the entry to represent any edits to the data files in a second file format compatible with the semantic dataset. For example, the server can execute the encoder in accordance with the request and generate an updated embedding (e.g., a second embedding that can be based on the first embedding). In some embodiments, the server can then modify the entry based on both the updated data files, the original embedding, and/or the updated embedding. For example, the server can integrate these updated embedding into the semantic dataset by adding or altering the lists in the corresponding file entries, for instance, upon receiving requests from client devices to make these updates. In this way, the server can maintain the semantic dataset and establish a time series of initial entries, modifications, and/or deletions from the semantic dataset.

At operation 308, the server can obtain a query having a first query format. For example, the server can obtain a query having a first query format, the query comprising one or more criteria. In some embodiments, the criteria can include one or more conditions that are specified to filter and retrieve specific data from the semantic dataset. The criteria can help narrow down the search results to match only the items that meet the conditions. For example, a query that is configured to be executed by the semantic dataset can include criteria such as expressions (e.g., strings of text, etc.) that are represented as language-based request for the server to return a specific subset of information from the semantic datasets. In examples, the criteria in a query can include various conditions such as user IDs, account numbers, or other unique identifiers that link the query to a particular user or entity. As will be understood, this association can allow the server to maintain data integrity and allow for confirmation that the file data is correctly attributed to the right user or entity.

In some embodiments, the server can receive a query from a client in a specific format. For example, the server can receive the query, where the query is represented as one or more text strings, a SQL query, etc., or combinations thereof. In this example, the query can include criteria specifying conditions that matching results can satisfy. In some examples, the criteria can include filters on specific fields, value ranges, text patterns, or other constraints. The server can then process this query to retrieve relevant data from the semantic dataset store that matches the provided criteria.

At operation 310, the server can reformat the query to generate an updated query that is compatible with the semantic dataset. For example, in response to obtaining the query in a first file format (e.g., as a text file), the server can reformat the query. In this example, the server can reformat the query to generate an updated query.

In some embodiments, the updated query can be formatted in accordance with the criteria of the second file format to be compatible with the semantic dataset. For example, the server can provide some or all of the query to an encoder (e.g., that is the same as, or similar to, the encoder used to generate the entries in the semantic dataset). In this example, the output of the encoder can include an embedding that represents an updated query that represents the query in the latent space described herein. In some embodiments, server can execute the updated query to search the semantic dataset and generate a query response. For example, the server can execute the updated query by comparing one or more aspects of the resulting embedding to a set of embeddings in the latent space that are within a threshold distance of the embedding corresponding to the updated query. The server can then map the embeddings that satisfy the threshold distance to corresponding portions of the semantic dataset to obtain the portions of the entries in the semantic dataset responsive to the query. Additionally, the system can analyze the original query (e.g., the structure of the original query) and the criteria that is compatible with the second file format and reformat the query to match the format and requirements of the semantic dataset to generate an updated query.

In some embodiments, the server can generate the updated query based on the relative position of a profile identifier indicated by the query within a set of profile identifiers. For example, the server can generate the updated query based on permissions associated with the relative position of the profile identifier within a hierarchy established by a plurality of profile identifiers. In an example, the server can analyze the original query to determine which profile identifiers are referenced and their positions within the query structure. In this example, the server then maps these profile identifiers to determine one or more operations that are permitted to be performed on the computing environment using that profile identifier, adjusting the query and/or identifying the embeddings in the latent space that the query can be executed against to maintain the correct relationships and data access patterns established by the hierarchy of profile identifiers as described herein.

In some embodiments, the server can generate the updated query for execution in accordance with a profile hierarchy established by a plurality of profile identifiers to cause the query response to include the at least a portion of the data files. In an example, the system can implement hierarchical query techniques, such as recursive Common Table Expressions (CTEs) or hierarchical query clauses, to traverse the profile hierarchy efficiently. In this example, the updated query can be structured to navigate through parent-child relationships, allowing all relevant data maintained in the semantic dataset at different levels of the hierarchy to be included in the query response. In this example, the updated query can include an indication of one or more attributes of each entry in the semantic dataset that can be used to identify entries that can be retrieved in response to execution of the updated query.

At operation 312, the server can execute the updated query on the semantic dataset to generate a query response (and obtain corresponding query results). For example, the server can execute the updated query on the semantic dataset to generate a query response that includes at least a portion of the data files in the second file format. In some examples, this query execution may be triggered in response to receiving a user request that indicates one or more portions of the semantic dataset.

In some embodiments, the server can execute the updated query on the semantic data set to identify embeddings that are within a threshold distance of the embedding generated for each entry in the semantic data set. In this example, the server can then identify portions of text that correspond to the embeddings that satisfy the threshold distance. In some examples, the server can then compare the portions of text identified as being correlated with embeddings within that threshold distance and filter the text in response to the relative position of the profile identifier used to create the query as described herein. Once filtered, the server can provide a response to the client device that generated the query to indicate and/or include the proportions of text responsive to the query to which the user has access.

In some embodiments, a retrieval-augmented generation model can be executed by a computing environment as described herein to process the query in coordination with access control logic maintained by a gateway computing device. The retrieval-augmented generation model can obtain a query represented as a natural language input received from a client device and generate an embedding representation of the query for comparison against one or more embeddings stored in the semantic dataset. In examples, the retrieval-augmented generation model can restrict the comparison operation to embeddings correlated with a profile identifier associated with the client device. For example, the retrieval-augmented generation model can determine a subset of embeddings indexed within a latent space that correspond to the profile identifier (e.g., which indicates whether access to the underlying data is permitted for the corresponding client device) and retrieve one or more entries in the semantic dataset that are associated with that subset. In this example, the retrieval-augmented generation model can generate a context vector based on the embeddings retrieved from the subset and provide the context vector to a query processor executing within the computing environment to produce query outputs or perform additional comparison operations. In at least some examples, the retrieval-augmented generation model can apply one or more pre-filtering conditions determined based on a classification of the user within a hierarchical profile structure before performing any similarity analysis. In this way, the retrieval-augmented generation model can limit query execution to a defined portion of the semantic dataset that corresponds to records accessible according to the user's role or position in the hierarchy represented by the profile mapping.

The retrieval-augmented generation model can be implemented using a variety of model architectures depending on the nature of the data and the processing requirements of the computing environment. In some embodiments, the retrieval-augmented generation model can incorporate an encoder-decoder architecture in which the encoder generates dense embeddings for input queries or documents, and the decoder produces response sequences or query expansions based on the retrieved context. Alternatively, the retrieval-augmented generation model can implement a transformer-based architecture, where both retrieval and generation operations are handled within a unified self-attention framework, allowing for contextual relationships to be learned between queries, embeddings, and stored semantic representations. Other implementations can include a hybrid configuration where a retriever module, such as a dual-encoder or bi-encoder, operates independently from a generative language model, allowing the retriever to identify semantically similar entries in a latent space and the generator to produce output sequences aligned with the retrieved context.

The retrieval-augmented generation model can receive multiple types of inputs during operation. For example, the retrieval-augmented generation model can receive a primary input that can include the query provided by a client device, where the query is represented as text, structured data, or multimodal input. The retrieval-augmented generation model can also accept embeddings derived from a semantic dataset or from external knowledge sources that are indexed in accordance with a latent space. In some instances, the embeddings derived from the semantic dataset can be pre-filtered to include the data accessible by the client device. During inference, a retriever module can obtain the one or more embeddings that are within a predetermined distance to the query embedding, while the generator module can use both the retrieved documents and the embedding representations as contextual input to generate an updated query, a semantic interpretation, or a natural-language response. The output of the retrieval-augmented generation model can include context vectors, refinement embeddings, or text-based responses that can be provided to a gateway computing device or client interface for display or further processing.

Training of the retrieval-augmented generation model can involve joint optimization of retrieval and generation components based on paired query and document data. For example, with respect to an encoder-decoder implementation of the retrieval-augmented generation model, the encoder can process input queries to generate embeddings, while a separate encoder can process candidate documents to produce a corresponding set of latent representations. The retrieval-augmented generation model can be configured to determine similarity scores between the query and document embeddings and update the retriever weights to increase alignment for true positive pairs and reduce alignment for negative pairs. The generator can then receive both the query and retrieved context to predict the desired output sequence, such as a reformulated query or explanation. Loss functions, such as cross-entropy loss for text generation and contrastive loss for retrieval accuracy, can be combined to jointly update weights throughout the network. In some embodiments, backpropagation can be implemented to propagate gradients through both the retriever and generator components, allowing the retrieval-augmented generation model to incrementally improve contextual relevance and response fidelity across training epochs.

In some embodiments, the retrieval-augmented generation model can further enhance indexing efficiency within the semantic dataset by generating enriched embedding representations that capture deeper contextual relationships between documents, queries, and entities. During indexing, the retrieval-augmented generation model can analyze content to identify latent semantic correlations, enabling it to create more precise embedding clusters that reduce redundancy and improve organization within the latent space. This refined indexing process can minimize the number of vector comparisons required during retrieval, effectively reducing query latency and computational overhead. As a result, searches executed across the semantic dataset can be performed more efficiently, returning relevant results with higher precision and lower processing time, particularly as the volume of stored embeddings increases.

In some embodiments, the query response can include a first query response (e.g., including one or more embeddings obtain by executing the query), and the server can generate a second query response based on the first query response to represent at least a portion of the data files in the first file format. For example, the first query response may contain raw or unstructured data (e.g., the embeddings representing the entries in the semantic dataset), while the second query response can be updated (e.g., reformatted, etc.) to include the text associated with each entry responsive to the query. In this example, the server can determine a correlation between one or more embeddings obtained in response to execution of the query on the semantic dataset and the portions of the entries (e.g., the text included in the text fields) and include the portions of the entries in the semantic dataset in the second query response. In some embodiments, before providing the second query response to subsequent modules or client devices, the server can summarize the query response to reduce redundancy and highlight essential information. For example, the server can invoke a large language model (LLM) or another suitable summarization model to generate a condensed textual summary of the data included in the query response. This summarized output can then be further processed to extract key elements, perform relevance analysis, or generate refined results suitable for display or downstream execution.

In some embodiments, the server can filter the query response in accordance with a relative position of a profile identifier indicated by the query. In examples, this relative position can reflect hierarchical relationships between users (correlated by their profile identifier), content to which the users have access, or data categories to which the users have access. In this example, by filtering the query response in accordance with the relative position of the profile identifier, the server can confirm that the data generated in response of the query is contextually appropriate and satisfies any access control rules established for the computing environment.

In some embodiments, the server can filter the second query response in accordance with a relative position of a profile identifier indicated by the query. For example, the server can apply additional filtering parameters to ensure that relevant portions of the entries included in the semantic dataset are included in the second query response. In examples where the profile identifier corresponds to a user role or an organizational department, this filtering process can allow the server to tailor the final output to align with established access granted to the user who caused the query to be generated.

In some embodiments, the server can determine a set of redactions based on a relative position of a profile identifier indicated by the query. For example, the server can determine a set of redactions that correspond to the access permissions indicated by the profile identifier. In this example, the server can apply these redactions to the second query response before providing the second query response to the client device that generated the query (e.g., either through the gateway computing device or directly to the client device). In some examples, these redactions may be configured to remove sensitive information from the displayed results. In some embodiments, in response to applying the redactions, the server can provide the second query response to the client device. For example, the server can provide the second query response to the client device to cause the client device to display at least a portion of the second query response. This can include causing a display device of the client device to output a representation of at least a portion of the second query response.

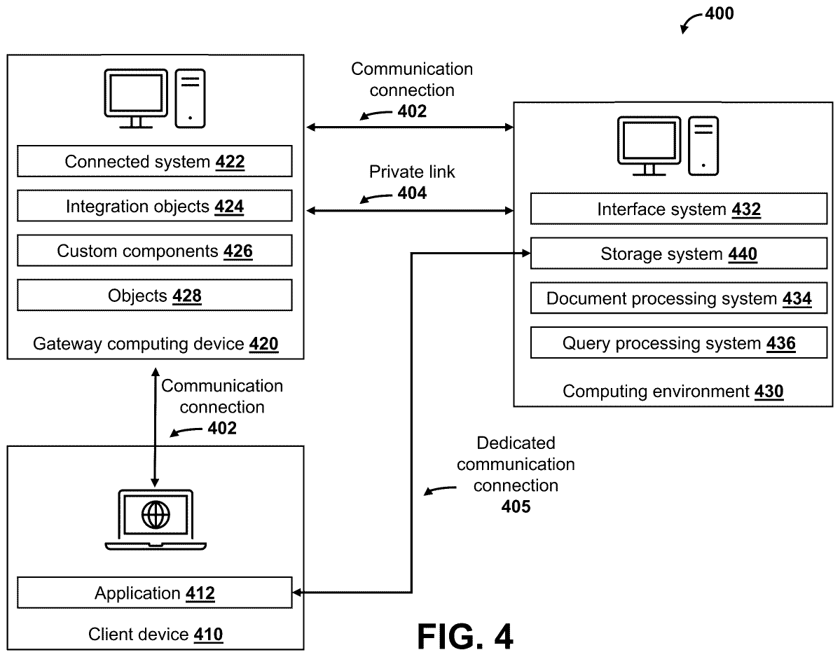

FIG. 4 illustrates an example implementation of an environment 400 for managing communication with a computing environment, according to an embodiment. The environment 400 can include one or more devices that are the same as, or similar to, the environment 100 of FIG. 1. As illustrated, the environment 400 includes a client device 410, a gateway computing device 420, a computing environment 430 and a dataset 140. Various components depicted in FIG. 4 can belong to an organization that is involved in controlling access to computing resources in computing environments that are the same as, or similar to, the computing environment 130 of FIG. 1. The environment 400 is not confined to the components described herein and can include additional or other components, not explicitly illustrated for brevity, which are configured to be considered within the scope of the embodiments described herein.

The environment 400 can include a client device 410, a gateway computing device 420, and a computing environment 430. The client device 410 can include an application 412. The gateway computing device 420 can include a connected system 422, integration objects 424, custom components 426, and objects 428. The computing environment 430 can include an interface system 432, a storage system 440, a document processing system 434, and a query processing system 436. The environment 400 can further include a communication connection 402 between the gateway computing device 420 and the computing environment 430, a communication connection 402 between the client device 410 and the gateway computing device 420, and private links 404 that connect both the client device 410 and the gateway computing device 420, and the gateway computing device 420 and the computing environment 430.

The environment 400 can include multiple devices that exchange data through coordinated communication connections to perform operations associated with distributed document processing and query execution. In some embodiments, the client device 410 can transmit structured requests through the application 412 to the gateway computing device 420 for processing. For example, the application 412 can generate a request payload containing identifiers, request metadata, or file parameters that establish a profile between the client device 410 and the storage system 440 of the computing environment 430. In this example, the computing environment 430 can configure storage or retrieval operations that are subsequently directed to the computing environment 430. In examples, the gateway computing device 420 can process each request to determine corresponding routing parameters and transmit the updated request through the communication connection 402 to the computing environment 430. The computing environment 430 can then execute the referenced operation, such as storing documents, processing queries within semantic datasets, and/or generating formatted response data. In some examples, the communication connection 402 and private links 404 can function as concurrent data pathways that transmit request payloads, response packets, or dataset updates between the client device 410, the gateway computing device 420, and the computing environment 430 in a synchronized manner during execution of these operations.

The environment 400 can represent a distributed computing system that facilitates coordinated data exchange between a client device 410, a gateway computing device 420, and a computing environment 430. The environment 400 can include communication connections 402, including private links 404, that logical and/or physical pathways for transmitting information between these components. In some embodiments, the environment 400 can process multiple concurrent operations involving data transfer, query execution, and storage activities initiated by the client device 410. For example, the gateway computing device 420 can route a storage request originating at the client device 410 (or other client devices that are not expressly illustrated) through communication connection 402 and forward an updated request through communication connection 402 to the computing environment 430. In this example, the computing environment 430 can execute one or more backend operations such as storing data, retrieving stored entries from a dataset maintained by the storage system 440, and/or generating a response associated with a submitted query. In some embodiments, private link 404 can establish a communication channel and communication session between the gateway computing device 420 and the computing environment 430 to maintain continuous connectivity during the exchange of request and response packets. The combination of these components and links can allow environment 400 to perform coordinated data transmission across distributed subsystems operating in separate physical or virtual network domains.

The client device 410 can include a computing device configured in accordance with a client-side setup for Appian® users. The client device 410 can be configured to execute one or more web browsers that can establish communication connections with the gateway computing device 420 in accordance with HTML, CSS, and JavaScript (JS), which can be used together to create web-based interfaces for communicating with the gateway computing device 420 and/or a server implementing the computing environment 430. For example, HTML can provide the structure for the interface, CSS styles the appearance, and JavaScript can enable dynamic interactions, allowing for real-time data exchange and control of the gateway computing device 420 through protocols like WebSockets or HTTP requests.

The application 412 can be a client-executed software interface that facilitates communication between the client device 410 and the gateway computing device 420. In some embodiments, the application 412 can be implemented as a web-based interface, a mobile application, or a browser-executed platform that transmits structured requests and receives response data through network protocols. For example, the application 412 can transmit a storage request, a query, or an upload instruction to the gateway computing device 420 to cause execution of an operation within a computing environment 430. In some examples, the application 412 can transmit the requests using standardized web protocols such as Hypertext Transfer Protocol (HTTP) and/or persistent WebSocket connections through communication connection 402 to establish and maintain data exchange sessions. In at least some examples, the application 412 can use Hypertext Markup Language (HTML) to indicate the document structure of a displayed interface, Cascading Style Sheets (CSS) to specify interface attributes, and JavaScript (JS) to control or dynamically render structured response data originating from the gateway computing device 420. Each response can be rendered within the graphical interface of the client device 410 to display tabular content, status indicators, or other structured representations based on the response data.

In some embodiments, the gateway computing device 420 can be configured to allow for communication between users controlling the client device 410 and the gateway computing device 420 through one or more protocols. As illustrated, the gateway computing device 420 can receive requests through supported web browsers that connect via a public network such as the Internet. In some examples, these requests can be processed using web technologies including HTML for content structure, CSS for styling, and JavaScript for client-side functionality. In some embodiments, the gateway computing device 420 can be configured to route these processed requests to the appropriate systems and/or devices within the computing environment 430 (e.g., an Appian® App server environment or similar environments). In this example, the gateway computing device 420 can direct requests to connected systems for external integrations, integration objects for data transformation, custom components for specialized functionality, and objects for core platform operations. In examples where Java®-based processing is involved, the gateway computing device 420 can allow for routing to a Java® runtime environment that underlies these server-side components. As will be understood, the gateway computing device 420 can be configured to operate as an intermediary, managing communication of data between the browsers of the client device 410 and the computing environment 430.

In some embodiments, the gateway computing device 420 can establish a dedicated communication connection 405 (e.g., that is the same as, or similar to, the communication connection 402) with computing environment 430 to allow for data transmission therebetween (e.g., between the application 412 and the storage system 440) via one or more networks, which may include any number of public data communication networks, such as the Internet, through various web protocols and web-scripting languages (e.g., HTTP/HTTPS, TCP/IP, VPN, HTML, JavaScript), among other web-communication technologies, for establishing and handling client-server communications and secure client-side connection requirements. For instance, the dedicated communication connection 405 allows users operating the client device 410 to access the storage system 440, among other server-side components of the computing environment 430, via an established TCP/IP communication session or channel over the Internet.

Optionally, in some embodiments, the gateway computing device 420 can initiate the dedicated communication connection 405 by performing various inter-device handshake and/or authentication operations through the various web protocols and web-scripting languages (e.g., HTTP/HTTPS, TCP/IP, VPN, HTML, JavaScript), among other web-communication technologies, for establishing and handling secure client-server communications and secure client-side connection requirements. In such optional embodiments, the gateway computing device 420 can grant access rights or permit the storage system 440 to receive data from the application 412 of the client device 410 directly (e.g., bypassing the gateway computing device 420). In some examples, once the initial authentication is complete, the gateway computing device 420 can create the dedicated communication connection 405 as an encrypted communication connection (sometimes referred to as an encrypted tunnel) with the computing environment 430. The encrypted communication connection can allow users operating the client device 410 to securely access the storage system 440 or other server-side components of the computing environment 430.

The connected system 422 can be a communication interface that allows the gateway computing device 420 to transmit information to internal or external computing systems accessible to the computing environment 430. In some embodiments, the connected system 422 can be implemented as an interface layer that coordinates communication between distributed application services or backend computing resources. For example, the connected system 422 can transmit and receive structured data packets or formatted requests between the gateway computing device 420 and the computing environment 430 through a communication connection 402. In some examples, the connected system 422 can format, queue, and exchange application requests by executing standardized message protocols such as REST (Representational State Transfer), SOAP (Simple Object Access Protocol), or message-based protocols that exchange JSON (JavaScript Object Notation) or XML (Extensible Markup Language) data representations. In other examples, the connected system 422 can use a stateless protocol architecture that allows multiple operations to be transmitted concurrently between the gateway computing device 420 and the computing environment 430 without requiring continuous session maintenance. The connected system 422 can thereby maintain consistent request boundaries, timestamp parameters, and payload schemas across consecutive message exchanges to ensure consistency between application states maintained on each side of the communication interface.

The integration objects 424 can include data adapters that align exchanged data formats and parameter structures between the gateway computing device 420 and the computing environment 430. In some embodiments, the integration objects 424 can restructure transmitted messages to conform to a standardized schema or API specification associated with the computing environment 430. For example, the integration objects 424 can reformat a data payload received from the client device 410 into a structure defined by the schemas used by an interface system 432 of the computing environment 430. In examples, the integration objects 424 can execute transformation processes such as XML-to-JSON conversions, field mapping adjustments, and dynamic schema validation before message transmission. In at least some examples, the integration objects 424 can further modify field attributes, such as renaming elements, casting data types, or aggregating multiple records into a batch prior to transmission through the communication connection 402. In some embodiments, the integration objects 424 can implement intermediary processing logic that performs real-time restructuring of field sets to meet destination interface parameters. The transformation rules applied by integration objects 424 can include statically preconfigured mappings or dynamically loaded mapping templates to synchronize record synchronization processes between the gateway computing device 420 and the computing environment 430.

The custom components 426 can include software components that process or generate semantic data used for query or document processing functions. In some embodiments, the custom components 426 can perform operations such as document parsing, metadata assignment, tokenization, or embedding generation to create data representations compatible with a semantic dataset maintained by the computing environment 430. For example, the custom components 426 can convert unstructured textual data received from the client device 410 into intermediate embeddings or structured tokens for indexing or storage. In some examples, the custom components 426 can cooperate with other components of the gateway computing device 420 to reformat received queries into a latent-space compatible form, for example, as described with respect to operations 302-312 of FIG. 3. The custom components 426 can therefore act as pre-processors that prepare data and queries for execution on the downstream semantic or intelligent document processing systems implemented within the computing environment 430.

The objects 428 can represent application-level entities or callable constructs accessible by the gateway computing device 420 to interface with the computing environment 430. In some embodiments, the objects 428 can indicate executable data structures or runtime API interfaces that store references to integration objects 424 or custom components 426. For example, the objects 428 can indicate procedural links used for invoking query execution commands, dataset update functions, or document ingestion instructions through the communication connection 402. In some examples, the objects 428 can include wrappers for remote procedural calls or standardized method invocations implemented across both the gateway computing device 420 and the computing environment 430. The objects 428 can thereby function as a logical abstraction layer that allows the gateway computing device 420 to retrieve, update, and transmit structured entities associated with semantic datasets or document processing pipelines managed by the computing environment 430.

In some embodiments, the computing environment 430 can include a serverless application (e.g., associated with the interface system 432) that implements a Web Application Firewall (WAF), an API Gateway, and a Lambda Authorizer. In some embodiments, the WAF can include a security measure designed to protect web applications by filtering and monitoring HTTP traffic between a web application and the Internet to prevent attacks such as SQL injection, cross-site scripting (XSS), and other web exploits. In embodiments, the API Gateway can be configured to operate as an entry point for applications to access data, business logic, or functionality from backend services. In examples, the API gateway can handle tasks involved in accepting and processing concurrent API calls, including traffic management, authorization and access control, monitoring, and API version management. In some embodiments, the Lambda Authorizer can include a module that uses Amazon Web Services (AWS®) Lambda functions to control access to APIs. The Lambda Authorizer can allow for custom authorization logic to be implemented, enabling the validation of tokens, API keys, or other credentials before granting access to the API. Together, these components enhance the security, scalability, and manageability of the computing environment 430.

In some embodiments, the computing environment 430 can implement storage service APIs (e.g., S3 APIs) and storage containers (e.g., S3 buckets), referred to as semantic datasets (maintained by the storage system 440), to efficiently store and manage data. By implementing these storage service APIs, the computing environment 430 can perform various operations such as uploading, retrieving, and deleting data within these semantic datasets. Additionally, the computing environment 430 can utilize a Virtual Private Cloud (VPC) to implement OpenSearch and OpenSearch APIs. This setup can allow for secure and scalable search capabilities within the semantic datasets. The VPC can allow for the data to remain isolated and protected, while OpenSearch APIs can allow for advanced search functionalities, further allowing a client device to query and retrieve relevant information from the semantic datasets as described herein.

In some embodiments, the computing environment 430 can implement an intelligent document processing (IDP) system (e.g., associated with the document processing system 434). For example, the computing environment 430 can implement an intelligent document processing (IDP) system to process data files and store them in the semantic datasets (maintained by the storage system 440). This computing environment 430 can use implement components to enhance its functionality. For instance, a NoSQL database service (e.g., Amazon® DynamoDB®) can be used to store and retrieve structured data. An optical character recognition (OCR) service (e.g., Textract®) can extract text and data from scanned documents, while a machine learning service (e.g., Bedrock®) can provide foundational models for various AI-based tasks. Serverless compute services (Lambda®) can execute code in response to triggers, and workflow orchestration services (Step Functions®) can coordinate the execution of multiple tasks. Additionally, a natural language processing service (e.g., Comprehend®) can analyze text to extract insights, and a machine learning platform (e.g., SageMaker®) can build, train, and deploy machine learning models. Together, these components allow the IDP system to process, analyze, and store data files in a structured and efficient manner within the semantic datasets (maintained by the storage system 440) that are managed in the semantic datasets (maintained by the storage system 440).

The storage system 440 can include one or more hardware storage devices or cloud-based storage services implemented by the computing environment 430 to host datasets and processed files. In some embodiments, the storage system 440 can include storage containers such as object repositories, database clusters, or managed storage frameworks that maintain data persistence for semantic datasets. For example, the storage system 440 can include cloud-native storage containers implemented as S3 buckets or equivalent services adapted to store structured and unstructured files received from the gateway computing device 420. In at least some examples, the storage system 440 can execute upload operations, retrieval operations, and update operations in coordination with the gateway computing device 420. For example, the storage system 440 can receive file uploads transmitted through a temporary access link generated by the gateway computing device 420 (e.g., via the dedicated communication connection 405 between the client device 410 and the computing environment 430) when a corresponding file size satisfies a defined transfer threshold. In some embodiments, the storage system 440 can perform storage operations using storage application programming interfaces (APIs) such as S3 APIs or equivalent APIs to transmit and retrieve stored entries efficiently. The storage system 440 can perform file-level and bucket-level actions such as version control, indexing, key mapping, or metadata tracking using APIs maintained by the computing environment 430 to maintain the usability of datasets stored within the computing environment 430.

The communication connection 402 can provide a data pathway between the gateway computing device 420 and the computing environment 430 for synchronized data exchange. In some embodiments, the communication connection 402 can function as an application programming interface (API) or a message-based interface that transmits structured requests and responses between the gateway computing device 420 and the computing environment 430. In examples, the communication connection 402 can be used to transmit updated requests, responses, or configuration commands associated with profile mappings maintained by the gateway computing device 420. For example, the communication connection 402 can transmit updated requests containing hierarchical profile identifiers that correspond to operations initiated on the computing environment 430. In at least some examples, the communication connection 402 can operate using encrypted protocols such as Hypertext Transfer Protocol Secure (HTTPS) or secured message queues to facilitate reliable packet transfer. The communication connection 402 can maintain session-based authentication tokens and coordinate asynchronous data transmission to maintain synchronized state consistency between the gateway computing device 420 and the computing environment 430.

The private link 404 can be a point-to-point communication channel used to securely connect the client device 410 and/or the computing environment 430. In some embodiments, the private link 404 can implement a virtual private network (VPN) or an encrypted tunnel configured within a private subnet to isolate traffic exchanged among connected devices. In examples, the private link 404 can transmit sensitive or protected information such as metadata identifiers, file uploads, or operational payloads while limiting exposure to external networks. For example, the private link 404 can allow transfer of encrypted credentials and segmented upload packets directly between authenticated devices during active communication sessions. In some examples, the private link 404 can be established using secured protocols that specify encryption standards and connection timeouts. In this example, the private link 404 can implement Transport Layer Security (TLS) or Secure Sockets Layer (SSL) cryptography to protect streamed data during file upload and query processing operations executed between the gateway computing device 420 and the computing environment 430.

The communication connection 402 can be a data pathway that allows the client device 410 to transmit requests and receive responses through the gateway computing device 420. In some embodiments, the communication connection 402 can carry requests such as file storage operations, query initiations, or retrieval requests generated by an application 412 executed at the client device 410. For example, the communication connection 402 can transmit Hypertext Transfer Protocol (HTTP) request payloads containing operational metadata or profile-mapping identifiers to the gateway computing device 420. In some examples, the communication connection 402 can operate using persistent or session-based transport protocols within a network layer stack of the client device 410. For example, the communication connection 402 can establish and maintain WebSocket sessions for continuous request streaming or transmit discrete transactions through standard HTTP connections. The communication connection 402 can thereby facilitate bidirectional message exchange between the client device 410 and the gateway computing device 420 as part of coordinated processing sequences performed across the environment 400.

The various illustrative logical blocks, modules, circuits, and algorithm steps described in connection with the embodiments disclosed herein can be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans can implement the described functionality in varying ways for each particular application, but such implementation decisions should not be interpreted as causing a departure from the scope of this disclosure or the claims.

Embodiments implemented in computer software (e.g., computer programs, computer program products, etc.) can be implemented in software, firmware, middleware, microcode, hardware description languages, or any combination thereof. A code segment or machine-executable instructions can represent a procedure, a function, a subprogram, a program, a routine, a subroutine, a module, a software package, a class, or any combination of instructions, data structures, or program statements. A code segment can be coupled to another code segment or a hardware circuit by passing or receiving information, data, arguments, parameters, or memory contents. Information, arguments, parameters, data, etc., can be passed, forwarded, or transmitted via any suitable means, including memory sharing, message passing, token passing, network transmission, etc.

The actual software code or specialized control hardware used to implement these systems and methods is not limiting of the claimed features or this disclosure. Thus, the operation and behavior of the systems and methods were described without reference to the specific software code being understood that software and control hardware can be designed to implement the systems and methods based on the description herein.

When implemented in software, the functions can be stored as one or more instructions or code on a non-transitory computer-readable or processor-readable storage medium. The steps of a method or algorithm disclosed herein can be embodied in a processor-executable software module, which can reside on a computer-readable or processor-readable storage medium. A non-transitory computer-readable or processor-readable media includes both computer storage media and tangible storage media that facilitate the transfer of a computer program from one place to another. A non-transitory processor-readable storage media can be any available media that can be accessed by a computer. By way of example, and not limitation, such non-transitory processor-readable media can comprise RAM, ROM, EEPROM, CD-ROM or other optical disk storage, magnetic disk storage or other magnetic storage devices, or any other tangible storage medium that can be used to store desired program code in the form of instructions or data structures and that can be accessed by a computer or processor. Disk and disc, as used herein, include compact disc (CD), laser disc, optical disc, digital versatile disc (DVD), floppy disk, and Blu-ray disc where disks usually reproduce data magnetically, while discs reproduce data optically with lasers. Combinations of the above should also be included within the scope of computer-readable media. Additionally, the operations of a method or algorithm can reside as one or any combination or set of codes or instructions on a non-transitory processor-readable medium or computer-readable medium, which can be incorporated into a computer program product.

The preceding description of the disclosed embodiments is provided to enable any person skilled in the art to make or use the embodiments described herein and variations thereof. Various modifications to these embodiments will be readily apparent to those skilled in the art, and the principles defined herein can be applied to other embodiments without departing from the spirit or scope of the subject matter disclosed herein. Thus, the present disclosure is not intended to be limited to the embodiments shown herein but is to be accorded the widest scope consistent with the following claims and the principles and novel features disclosed herein.

While various aspects and embodiments have been disclosed, other aspects and embodiments are contemplated. The various aspects and embodiments disclosed are for purposes of illustration and are not intended to be limiting, with the true scope and spirit being indicated by the following claims.

What is claimed is:

1. A system comprising:
one or more processors configured to:
obtain, by a gateway computing device, an initial request to cause a server that is accessible by the gateway computing device to perform one or more operations;
determine, by the gateway computing device, a mapping between the initial request and a profile maintained by the server that is associated with the initial request;
generate, by the gateway computing device, an updated request based on the initial request and the mapping between the initial request and the profile;
provide, by the gateway computing device, the updated request to the server to cause the server to execute one or more operations in accordance with the initial request;
obtain, by the gateway computing device, a response to the initial request, the response representing the one or more operations executed by the server in response to the updated request; and
provide the response to a client device that initiated the initial request to cause the client device to generate a graphical user interface (GUI) in accordance with the response.

2. The system of claim 1, wherein the one or more processors configured to determine the mapping are configured to:
extract a user identifier based on the initial request; and
compare the user identifier to the mapping to determine a profile identifier within a profile structure,
wherein the one or more processors configured to generate the updated request are configured to:
generate the updated request based on a hierarchical position of the profile identifier within the profile structure.

3. The system of claim 2, wherein the one or more processors configured to generate the updated request are configured to:
generate the updated request to configure the server to execute the one or more operations in accordance with the hierarchical position of the profile.

4. The system of claim 3, wherein the one or more processors configured to cause the server to execute the one or more operations in accordance with the hierarchical position of the profile are configured to:
instruct the server to execute one or more queries based on the updated request; and
in response to receiving query results in accordance with the one or more queries, update the query results based on the hierarchical position of the profile.

5. The system of claim 1, wherein the one or more processors are further configured to:
obtain, by the gateway computing device, a storage request to cause the server to store at least one file that is associated with the profile; and
provide, by the gateway computing device, the storage request to the server to cause the server to store the at least one file in accordance with the profile.

6. The system of claim 5, wherein the one or more processors are further configured to:
obtain, by the gateway computing device, a temporary access link that comprises instructions for configuring a communication connection with the server within a threshold period of time measured from a point at which the temporary access link is created; and
provide, by the gateway computing device, the temporary access link to a client device to allow the client device to establish the communication connection with the server.

7. The system of claim 6, wherein the one or more processors are further configured to:
determine that a size of the at least one file satisfies a transfer threshold,
wherein the one or more processors configured to obtain the temporary access link are configured to:
obtain the temporary access link in response to determining that the size of the at least one file satisfies the transfer threshold.

8. A method comprising:
obtaining, by one or more processors, an initial request to cause a server that is accessible by a gateway computing device to perform one or more operations;
determining, by the one or more processors, a mapping between the initial request and a profile maintained by the server that is associated with the initial request;
generating, by the one or more processors, an updated request based on the initial request and the mapping between the initial request and the profile;
providing, by the one or more processors, the updated request to the server to cause the server to execute one or more operations in accordance with the initial request;
obtaining, by the one or more processors, a response to the initial request, the response representing the one or more operations executed by the server in response to the updated request; and
providing, by the one or more processors, the response to a client device that initiated the initial request to cause the client device to generate a graphical user interface (GUI) in accordance with the response.

9. The method of claim 8, wherein determining the mapping comprises:
extracting, by the one or more processors, a user identifier based on the initial request; and
comparing, by the one or more processors, the user identifier to the mapping to determine a profile identifier within a profile structure,
wherein generating the updated request comprises:
generating, by the one or more processors, the updated request based on a hierarchical position of the profile identifier within the profile structure.

10. The method of claim 9, wherein generating the updated request comprises:
generating, by the one or more processors, the updated request to configure the server to execute the one or more operations in accordance with the hierarchical position of the profile.

11. The method of claim 10, wherein configuring the server to execute the one or more operations in accordance with the hierarchical position of the profile comprises:
configuring, by the one or more processors, the server to execute one or more queries based on the updated request; and
in response to receiving query results in accordance with the one or more queries, updating, by the one or more processors, the query results based on the hierarchical position of the profile.

12. The method of claim 8, further comprising:
obtaining, by the one or more processors, a storage request to cause the server to store at least one file that is associated with the profile; and
providing, by the one or more processors, the storage request to the server to cause the server to store the at least one file in accordance with the profile.

13. The method of claim 12, further comprising:
obtaining, by the one or more processors, a temporary access link that comprises instructions for configuring a communication connection with the server within a threshold period of time measured from a point at which the temporary access link is created; and
provide, by the gateway computing device, the temporary access link to a client device to allow the client device to establish the communication connection with the server.

14. The method of claim 13, further comprising:
determining, by the one or more processors, that a size of the at least one file satisfies a transfer threshold,
wherein obtaining the temporary access link comprises:
obtaining, by the one or more processors, the temporary access link in response to determining that the size of the at least one file satisfies the transfer threshold.

15. A non-transitory computer-readable medium storing instructions that, when executed by one or more processors, cause the one or more processors to:
obtain an initial request to cause a server that is accessible by a gateway computing device to perform one or more operations;
determine a mapping between the initial request and a profile maintained by the server that is associated with the initial request;
generate an updated request based on the initial request and the mapping between the initial request and the profile;
provide the updated request to the server to cause the server to execute one or more operations in accordance with the initial request;
obtain a response to the initial request, the response representing the one or more operations executed by the server in response to the updated request; and
provide the response to a client device that initiated the initial request to cause the client device to generate a graphical user interface (GUI) in accordance with the response.

16. The non-transitory computer-readable medium of claim 15, wherein the instructions that cause the one or more processors to determine the mapping cause the one or more processors to:
extract a user identifier based on the initial request; and
compare the user identifier to the mapping to determine a profile identifier within a profile structure,
wherein the instructions that cause the one or more processors to generate the updated request cause the one or more processors to:
generate the updated request based on a hierarchical position of the profile identifier within the profile structure.

17. The non-transitory computer-readable medium of claim 16, wherein the instructions that cause the one or more processors to generate the updated request cause the one or more processors to:
generate the updated request to configure the server to execute the one or more operations in accordance with the hierarchical position of the profile.

18. The non-transitory computer-readable medium of claim 17, wherein the instructions that cause the one or more processors to configure the server to execute the one or more operations in accordance with the hierarchical position of the profile cause the one or more processors to:
configure the server to execute one or more queries based on the updated request; and
in response to receiving query results in accordance with the one or more queries, update the query results based on the hierarchical position of the profile.

19. The non-transitory computer-readable medium of claim 15, wherein the instructions further cause the one or more processors to:
obtain a storage request to cause the server to store at least one file that is associated with the profile; and
provide the storage request to the server to cause the server to store the at least one file in accordance with the profile.

20. The non-transitory computer-readable medium of claim 19, wherein the instructions further cause the one or more processors to:
obtain a temporary access link that comprises instructions for configuring a communication connection with the server within a threshold period of time measured from a point at which the temporary access link is created; and
provide the temporary access link to a client device to allow the client device to establish the communication connection with the server.
